(19) United States
(12) Patent Application Publication
(10) Pub. No.: US 2011/0031136 A1
(43) Pub. Date: Feb. 10, 2011

(54) Artist Brush Holder

(76) Inventor: Mickey Lynn Strain, Arabi, LA (US)

Correspondence Address: Leyendecker & Lemire, LLC, Suite 280, 9137 E Mineral Circle, Centennial, CO, 80112, US

(21) Appl. No.: 12/537,417

(22) Filed: Aug. 7, 2009

(51) Int. Cl. B44D 3/00; B65D 85/00

(52) U.S. Cl. 206/1.7; 206/372

(57) ABSTRACT

Described herein are embodiments for an apparatus for holding artist supplies in an upright manner. The apparatus comprises a first tier having a first plurality of round openings with a first diameter. A receptacle is positioned below each of the round openings and resilient elastomeric membranes having at least one slit cover each of the first plurality of round openings on the first tier. The apparatus also has a second tier with a second plurality of round openings having a second diameter disposed thereon. Each of the round openings are covered with a slit resilient elastomeric membrane and open to a receptacle positioned directly below the second plurality of round openings. A third tier having a third plurality or round openings with a third diameter is also included. Each of the third plurality of round openings is covered with a slit resilient elastomeric membrane and opens to a receptacle positioned directly below the round openings.

### TECHNICAL FIELD

The invention generally relates to a device for holding artist supplies.

### BACKGROUND

One of the most basic and well known tools of an artist is a paintbrush. An artist may use many different sizes and types of paintbrushes when painting a single work. Some of the types of paintbrushes include round, flat, bright, fan, and filbert to name a few. Paintbrushes also come in a variety of sizes including 10/0, 7/0, 6/0, 5/0, 4/0, 000, 00, 0, 1, 2, 3, 4, 5, 6, 7, 8, 9, 10, 11, 12, 13, 14, 16, 18, 20, 22, 24, 25, 26, 28, and 30. In addition to having a variety of types and sizes, different materials may be used in constructing a paintbrush. For example, the bristle of the paintbrush may be made from a variety of different materials. The materials include sable hair, ox hair, squirrel hair, goat hair, mongoose hair, hog bristle or synthetic hair.

Given the various types, sizes and material available, purchasing a number of paintbrushes in a variety types and sizes can be an expensive undertaking. Thus, once a paintbrush has been purchased, it may be desirable to securely store the paintbrushes in an easy and convenient manner. However, storing the paintbrushes properly can be difficult given the variety of types and sizes of the paintbrushes. What is needed therefore, is an apparatus that can store a plurality of paintbrushes of varying sizes in a secure manner that will not damage the handle or bristles of a paintbrush.

### BRIEF DESCRIPTION OF THE DRAWINGS

FIG. 1A is an isometric view of an apparatus for holding artist supplies according to embodiments.

FIG. 1B is a top view of the apparatus for holding artist supplies according to embodiments.

FIG. 1C is a side view of the apparatus for holding artist supplies according to embodiments.

FIG. 2A is a front view of the apparatus for holding artist supplies according to embodiments.

FIG. 2B is a side cutout view of the apparatus for holding artist supplies according to embodiments.

FIG. 3 is a functional view of the apparatus for holding artist supplies with a plurality of resilient elastomeric membranes covering the round openings according to embodiments.

### DETAILED DESCRIPTION

This disclosure will now more fully describe exemplary embodiments with reference to the accompanying drawings, in which specific embodiments are shown. Other aspects may be embodied in many different forms and the inclusion of specific embodiments in the disclosure should not be construed as limiting such aspects to the embodiments set forth herein. Rather, the embodiments depicted in the drawings are included to provide a disclosure that is thorough and complete and which fully conveys the intended scope to those skilled in the art. When referring to the figures, like structures and elements are shown throughout are indicated with like reference numerals.

### Terminology

The terms and phrases as indicated in quotes (“ ”) in this section are intended to have the meaning ascribed to them in this Terminology section applied to them throughout this document including the claims unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

The term “wave-shaped” means a non-linear shape. For example, the apparatus may have an s-shaped or sinusoidal configuration.

Described herein are embodiments for an apparatus for holding artist supplies. In embodiments the apparatus consists of a base coupled to at least a first side and a second side. The apparatus also has a first tier with a plurality of round openings disposed therein. Each round opening of the first plurality of round openings on the first tier of the apparatus has a first diameter. In addition, a receptacle is positioned below each of the round openings. Resilient elastomeric membranes having at least one slit cover each of the plurality of round openings on the first tier. The apparatus also has a second tier with a second plurality of round openings disposed thereon. Each of the second plurality of round openings have a second diameter and each of the round openings on the second tier open to a receptacle positioned directly below the second plurality of round openings. A second set of resilient elastomeric membranes cover the second plurality of round openings, with each of the second set of resilient elastomeric membranes having at least one slit. A third tier is also included on the apparatus. The third tier has a third plurality or round openings, each having a third diameter. A receptacle is positioned directly below each of the third plurality of round openings. A third set of resilient elastomeric membranes covers each of the third plurality of round openings on the third tier and each resilient elastomeric membrane has at least one slit.

In another embodiment, a multi-tiered apparatus for holding artist supplies is disclosed. The multi-tiered apparatus has a base and is coupled to first and second end pieces. The multi-tiered apparatus also includes a first planar surface on a first tier having a plurality of round holes with a first diameter. Each of the round holes on the first tier is covered with a resilient elastomeric membrane having at least one slit. Also included is a second planar surface on a second tier of the multi-tiered apparatus. The second planar surface has a second plurality of round holes. Each of the second plurality of round holes has a second diameter and is covered with a resilient elastomeric membrane having at least one slit. A third planar surface on a third tier of the multi-tiered apparatus is also included. The third planar surface has a third plurality of round holes with each of the third plurality of round holes having a third diameter. A resilient elastomeric membrane having at least one slit covers each of the third plurality of round holes.

In still yet other embodiments, an apparatus for holding a plurality of paintbrushes in an upright configuration is disclosed. According to such embodiments, the apparatus has a plurality of tiers with each tier having a wave-shaped configuration. A plurality of round openings are disposed on each tier of the plurality of tiers. Each of the plurality of round openings are covered with resilient elastomeric membranes having at least one slit to enable the paintbrush to be inserted into the round opening.

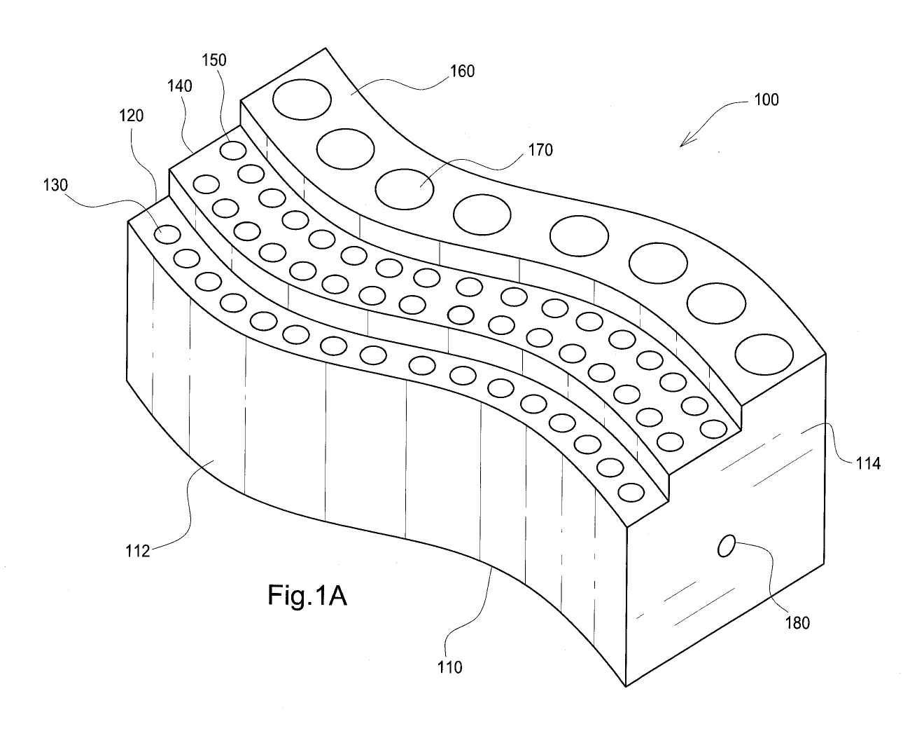

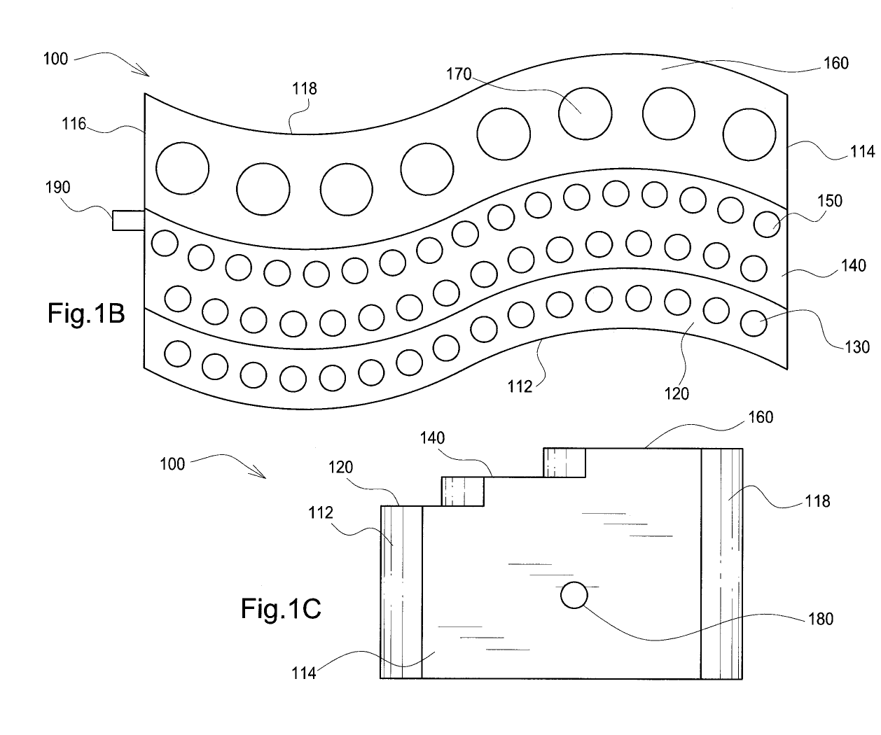

FIG. 1A is an isometric view of an apparatus 100 for holding artist supplies (e.g. paintbrushes) according to an embodiment. The apparatus may be made of plastic and/or wood or other similar materials. The apparatus may be constructed by injection molding each of the individual pieces and bonding or coupling each piece together to form a single unit.

The apparatus 100 consists of a base 110, a front portion 112, a first side portion 114, a second side portion 116 (FIG. 1B) and a rear portion 118 (FIG. 1B). According to embodiments, base 110, front portion 112, first side portion 114, second side portion 116 and rear portion 118 are coupled together to form a semi-enclosed structure with the top portion of the apparatus being separated into multiple tiers. In alternative embodiments, the apparatus may consist primarily of a base 110 and first and second sides 114 and 116 with the first and second sides being coupled to the first, second and third tiers. In still yet other embodiments, the apparatus 100 may consist of first and second sides supporting the multiple tiers while the base, front portion and rear portion are omitted. Many other combinations and arrangements of the base, front, rear, first side and second side portions are contemplated.

As shown by FIG. 1, the top portion of apparatus 100 consists of a first tier 120, a second tier 140, and a third tier 160. According to embodiments, a first plurality of round openings 130 are disposed on a planar surface of the first tier 120. In embodiments, the round openings 130 are aligned in a single row. Other embodiments provide that multiple rows of the first plurality round openings 130 can be disposed on the first tier 120. Each of the first plurality of round openings 130 on the first tier 120 has a first diameter. As will be explained in more detail below, the diameter of the plurality of round openings 130 on the first tier 120 of the apparatus 100 is smaller than a second plurality of round openings 150 on the second tier 140 and a third plurality of round openings 170 on the third tier 160.

In embodiments, the diameter of the first plurality of round openings 130 is large enough to hold smaller sized paintbrushes. For example, using the sizes of paintbrushes discussed above, the first plurality of round openings 130 on the first tier 120 of the apparatus 100 can have a diameter large enough to enable paintbrushes having a diameter of 10/0, 7/0, 6/0, 5/0, 4/0, 000, 00, 0, 1, 2, 3, and 4 to be inserted and stored in an upright position.

Embodiments provide that apparatus 100 also includes a second tier 140 with a second plurality of round openings 150 disposed on a planar surface of the second tier 140. Although FIG. 1A shows the second tier 140 having two rows of the second plurality of round openings 150, it is contemplated that the second tier 140 may have a single row of the second plurality of round openings 150. It is also contemplated that the second tier 140 can have three or more rows of the second plurality of round openings 150.

According to embodiments, each of the second plurality of round openings 150 has a second diameter slightly larger than the diameter of the first plurality of round openings 130 on the first tier 120. Continuing with the above example, the diameter of each of the second plurality of round openings 150 may have a diameter large enough to not only hold paintbrushes having a diameter ranging from 10/0-4, but can also hold paintbrushes having diameters of 5, 6, 7, 8, 9, 10, 11, 12, 13, 14, 16, and 18. In alternative embodiments, the diameter of the second plurality of round openings 150 may have a diameter equal to the diameter of the first plurality of round openings 130.

Apparatus 100 also includes a third tier 160 according to embodiments. In such embodiments, a third plurality of round openings 170 are disposed on a planar surface of the third tier 160 of the apparatus 100. The third plurality of round openings 160 can be configured as a single row as is shown in FIG. IA. Alternatively, the third tier 160 may have two or more rows of the third plurality of round openings 170. In embodiments, each of the third plurality of round openings 170 has a diameter that is larger than the first plurality of round openings 130 and the second plurality of round openings 150. Continuing with the above example, the diameter of the third plurality of openings 170 can be large enough to not only hold paintbrushes having diameters in the range of 10/0-18, but also hold paintbrushes having diameters of 20, 22, 24, 25, 26, 28, and 30. Alternatively, each of the round openings on each of the tiers may have the same diameter. Still yet other embodiments provide that the openings can have a variety of diameters disposed on the same tiers.

Included on a first side 114 of the apparatus 100 is a female, or receiving, portion 180 of a connection mechanism. In embodiments, a male, or connection, portion 190 (FIG. 1B) of the connection mechanism is coupled to a second side 116 (FIG. 1B) of the apparatus 100. In embodiments, the connection mechanism may be a hook and eye connector. Having connection mechanisms present on the apparatus 100 enables one apparatus, such as apparatus 100 to be coupled to a second apparatus having the connection mechanism. This may be done by placing the male portion 190 of the connection mechanism on a first apparatus into the female portion 180 of the connection mechanism in a second apparatus.

According to embodiments, the apparatus 100 has a non-linear, or wave-shaped, configuration. This configuration is extended throughout the entire apparatus 100. Thus, each of the first tier 120, second tier 140, and third tier 160 has the wave-shape configuration. In such embodiments, each of the rows of round openings on each tier also follows the wave-shape of the apparatus 100. Having a wave-shaped configuration can give the apparatus 100 more stability when an artist inserts and removes a paintbrush from one of the plurality of round openings. Alternative embodiments provide that the apparatus 100 may be configured in a variety of different non-linear shapes (for example an S-shape) that would increase the stability of the apparatus 100 as compared to an apparatus having a rectangle shaped base.

FIG. 1B is a top view of the apparatus 100 for holding artist supplies according to embodiments. As stated above and shown in FIG. 1B, the apparatus 100 consists of a first tier 120 having a first plurality of round openings 130 having a first diameter, a second tier 140 having a second plurality of round openings 150 with a second diameter, and a third tier 160 having a third plurality of openings 170 having a third diameter. According to embodiments, the width of the first tier 120 is smaller than the width of the second tier 140 and the third tier 160. In other embodiments, the width of the first tier can be equivalent to the width of the second tier and/or the third tier. The width of the second tier 140 can be large enough for two rows of the second plurality round openings 150 to be disposed on the surface. The width of the second tier 140 can also be equivalent to the width of the third tier 160 on which a single row of a third plurality of round openings 170 are disposed. Alternatively, the width of the second tier can be smaller than the width of the third tier yet larger than the width of the first tier 120.

FIG. 1B also shows a male portion 190 of a connection mechanism disposed on a second side 116 of the apparatus 100. The connection mechanism can be used to couple a first apparatus 100 to a similar second apparatus.

FIG. 1C is a side view of an apparatus 100 for holding artist supplies according to embodiments. As shown in FIG. 1C, the apparatus 100 has a wave-shaped configuration according to embodiments. When looking at the apparatus 100 from the side as shown in FIG. 1C, at least portions of the front side 112 and rear side 118 are visible as the wave-shape progresses from the first side 114 to the second side 116 (FIG. 1B). The wave-shaped configuration can give the apparatus 100 greater stability.

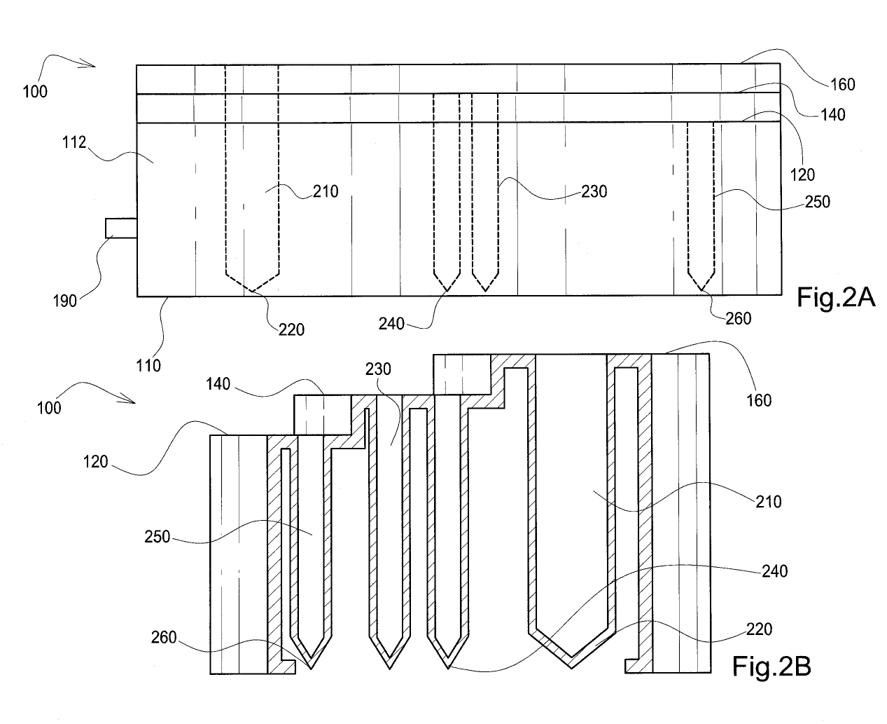

FIG. 2A is a front view of an apparatus 100 for holding artist supplies according to an embodiment. As shown in FIG. 2A, positioned directly below the third plurality of round openings 170 (FIG. 1A) on the third tier 160 of the apparatus 100, is a receptacle 210. According to embodiments, the receptacle 210 has a diameter that is equivalent to the diameter of the third plurality of round openings 170. The bottom of the receptacle 210 consists of a conical shaped well 220. The conical shaped well 220 acts to more securely hold a tapered end of a shaft of a paintbrush. Although FIG. 2A only shows one receptacle 210 and its corresponding conical shaped well 220 being placed under one of the third plurality of round openings 170, it is contemplated that a receptacle 210 and corresponding conical shaped well 220 is positioned under each of the third plurality of round openings 170 on the third tier 160 of the apparatus 100.

In embodiments, the length of the combination of the receptacle 210 and conical shaped well 220 is substantially equivalent to the distance between the third tier 160 and the base 110 of the apparatus 100. Alternative embodiments provide that the length of the receptacle 210 may be any size sufficient to securely hold a shaft of a paintbrush.

Embodiments provide that a receptacle 230 is positioned below the second plurality of round openings 150 on the second tier 140 of the apparatus 100. In such embodiments, the receptacle 230 has a diameter that is equivalent to the second plurality of round openings 150. A conical shaped well 240 is positioned at the bottom of the receptacle 230. The length of the receptacle, including the conical shaped well 240 is substantially equivalent to the distance between the second tier 140 and the base 110 of the apparatus 100. Alternative embodiments provide that the receptacle 230 may be shorter than the distance between the second tier 140 and the base 110 of the apparatus 100. Although only two receptacles 230 are shown in FIG. 2A, it is contemplated that a receptacle 230 and corresponding conical shaped wells 240 are located below each of the second plurality of round opening 150 on the second tier 140 of the apparatus 100.

In still yet other embodiments, a receptacle 250 and a conical shaped well 260 is positioned below each of the first plurality of round openings 130 on the first tier 120 of the apparatus 100. The diameter of the receptacle 250 is equivalent to the diameter of the first plurality of round openings 130. The length of the combination of the receptacle 250 and conical shaped well 260 is substantially equivalent to the distance between the top tier 120 and the base 110 of the apparatus 100. In alternative embodiments, the length of the receptacle 250 and conical shaped well 260 can have any length sufficient to securely hold at least a portion of a shaft of a paintbrush.

FIG. 2B is a side cutout view of an apparatus 100 for holding artist supplies according to embodiments. As shown in FIG. 2B, each of the receptacles 210, 230, and 250 are positioned below each of the first, second and third plurality of round openings on each of the first second and third tiers. Conical shaped wells 220, 240, and 260 are placed at the bottom of each of the receptacles 210, 230, and 250. According to embodiments, the length of the receptacles and corresponding wells is substantially equivalent to the distance between the base 110 (FIG. 1A) of the apparatus 100 and each of the tiers under which the receptacles are located.

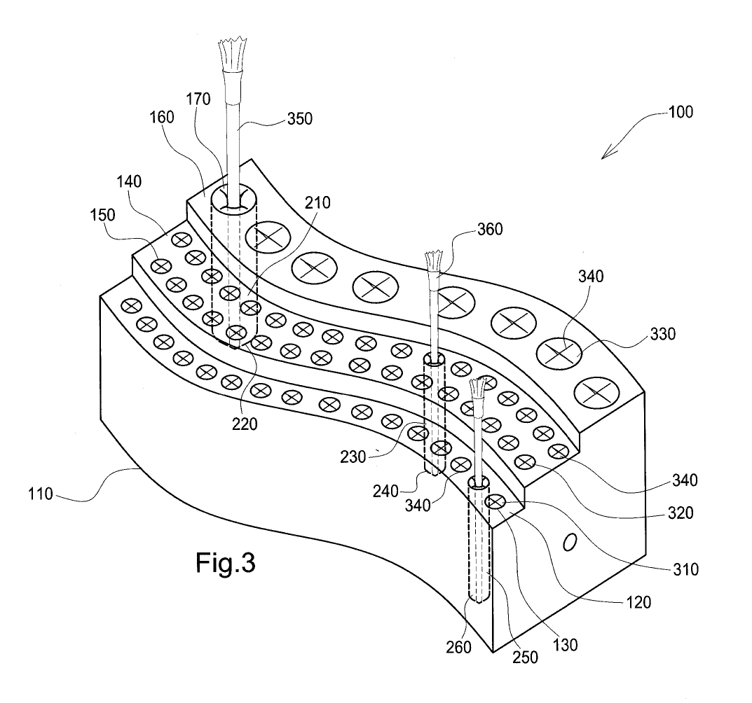

FIG. 3 shows an apparatus 100 for holding artist supplies with a plurality of resilient elastomeric membranes covering the plurality of round openings according to embodiments. According to embodiments, the resilient elastomeric membranes may be placed on top of each of the three tiers. Alternatively, the resilient elastomeric membranes may be placed between each of the tiers and the receptacles. The resilient elastomeric membranes act to secure the paintbrushes when they are being stored in an upright position. The resilient elastomeric membranes hold the paintbrushes in place and don't allow the shaft the paintbrush to come in contact with an inner portion of the round opening in which it is stored. As shown in FIG. 3, paintbrushes 350, 360, and 370 can each have differing diameters and be safely stored on the different tiers in an upright position.

According to embodiments, each of the first plurality of round openings 130 on the first tier 120 of the apparatus 100 has a resilient elastomeric membrane 310 covering the round opening. Embodiments provide that the resilient elastomeric membrane has at least one slit 340 on the face thereof to permit a shaft or handle of a paintbrush (e.g. paintbrush 370) to slide through the resilient elastomeric membrane 320 and rest inside the receptacle 250. The resilient elastomeric membrane 310, along with the conical shaped well 260 act in concert to securely hold the paintbrush in place when a diameter of the paintbrush 370 is smaller than the diameter of the first plurality of round openings 130.

As shown in FIG. 3, it is contemplated that each of the second plurality of round openings 150 on the second tier 140 of the apparatus 100 are covered by resilient elastomeric membranes 320 with one or more slits 340. In Embodiments, the diameter of each of the resilient elastomeric membranes 320 is large enough to fully cover the diameter of the second plurality of round openings 150. When a paintbrush 360, is inserted through the slits 340 in the resilient elastomeric membrane 320, the shaft of the paintbrush will be held in place in a secure manner without damaging the shaft. As previously stated, the tapered end of the shaft of the paintbrush 360 can fit inside the conical shaped well 240 to give an extra measure of stability when the paintbrush is being stored in an upright manner.

Embodiments also provide that resilient elastomeric membranes 330 cover each of the plurality of round openings 170 on the third tier 160 of the apparatus 100. Each of the resilient elastomeric membranes 330 on the third tier 160 have at least one slit 340 to enable a paintbrush 350 to slide through the resilient elastomeric membrane 330. The resilient elastomeric membrane functions to hold an upper portion of a shaft of the paintbrush 350 in place while the conical shaped well 220 holds a tapered end of the paintbrush 350 in place.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. An apparatus for holding artist supplies comprising:
a first tier having a first plurality of round openings wherein each of the first plurality of round openings has a first diameter;
a first set of resilient elastomeric membranes covering the first plurality of round openings, wherein each of the first set of resilient elastomeric membranes contain at least one slit above each of the first plurality of round openings;
a first plurality of receptacles positioned below each of the first plurality of round openings;
a second tier having a second plurality of round openings, wherein each of the second plurality of round openings has a second diameter;
a second set of resilient elastomeric membranes covering the second plurality of round openings, wherein each of the second set of resilient elastomeric membranes contain at least one slit above each of the second plurality of round openings;
a second plurality of receptacles positioned below each of the second plurality of round openings;
a third tier having a third plurality of round openings, wherein each of the third plurality of round openings has a third diameter; and
a third set of resilient elastomeric membranes covering the third plurality of round openings, wherein each of the third set of resilient elastomeric membranes contain at least one slit above each of the third plurality of round openings; and
a third plurality of receptacles positioned below each of the third plurality of round openings.

2. The apparatus of claim 1, wherein each of the first plurality of receptacles has a diameter that corresponds to the diameter of the first plurality of openings and a length that substantially corresponds to a distance between the first tier and a base of the apparatus.

3. The apparatus of claim 1, wherein each of the first plurality of receptacles has an enclosed conical shaped bottom.

4. The apparatus of claim 1, wherein each of the second plurality of receptacles has a diameter that corresponds to the diameter of the second plurality of openings and a length that substantially corresponds to a distance between the second tier and a base of the apparatus.

5. The apparatus of claim 1, wherein each of the second plurality of receptacles has an enclosed conical shaped bottom.

6. The apparatus of claim 1, wherein each of the third plurality of receptacles has a diameter that corresponds to the diameter of the third plurality of openings and a length that substantially corresponds to a distance between the third tier and a base of the apparatus.

7. The apparatus of claim 1, wherein each of the third plurality of receptacles has an enclosed conical shaped bottom.

8. The apparatus of claim 1, wherein a base, the first tier, the second tier and the third tier have a wave-shaped configuration.

9. The apparatus of claim 1, wherein each of the resilient elastomeric membranes is configured to receive and hold a shaft of a paintbrush in an upright position.

10. The apparatus of claim 1, further comprising a connection mechanism disposed on at least one side of the apparatus, wherein the connection mechanism is configured to couple one apparatus having the connection mechanism with another apparatus having another connection mechanism.

11. The apparatus of claim 10, wherein the connection mechanism is a hook and eye connector.

12. A multi-tiered apparatus for holding artist supplies, the multi-tiered apparatus comprising:
a base having a surface area from a first side to a second side of the multi-tiered apparatus;
a first planar surface on a first tier of the multi-tiered apparatus, wherein the first planar surface has a first plurality of round holes, each of the first plurality of round holes having a first diameter and covered with a resilient elastomeric membrane having at least one slit;
a second planar surface on a second tier of the multi-tiered apparatus, wherein the second planar surface has a plurality of round holes, each of the second plurality of round holes having a second diameter and covered with a resilient elastomeric membrane having at least one slit; and
a third planar surface on a third tier of the multi-tiered apparatus, wherein the third planar surface has a plurality of round holes, each of the third plurality of round holes having a third diameter and covered with a resilient elastomeric membrane having at least one slit.

13. The multi-tiered apparatus of claim 12, wherein the multi-tiered apparatus has a wave-shaped configuration.

14. The multi-tiered apparatus of claim 12, further comprising a plurality of receptacles positioned below each of the plurality of round holes on each of the first, second and third tiers.

15. The multi-tiered apparatus of claim 14, wherein each of the plurality of receptacles has a conically shaped bottom.

16. The multi-tiered apparatus of claim 12, further comprising a connection mechanism located on first and second sides of the multi-tiered apparatus for connecting the multi-tiered apparatus to a second multi-tiered apparatus.

17. An apparatus for holing a plurality of paintbrushes in an upright configuration, the apparatus comprising:
a plurality of tiers, wherein each tier has a wave-shaped configuration;
a plurality of round openings disposed on each of the plurality of tiers; and
a plurality of resilient elastomeric membranes covering each of the plurality of round openings, wherein each of the plurality of resilient elastomeric membranes has at least one slit.

18. The apparatus of claim 17, wherein at least one of the plurality of round openings has a diameter different from at least a second one of the plurality of round openings.

19. The apparatus of claim 17, further comprising a receptacle positioned below each of the plurality of round openings, wherein each receptacle has a conical shaped bottom.

20. The apparatus of claim 17, further comprising a hook and eye connector disposed on at least one side of the apparatus, wherein the hook and eye connector enables a first apparatus to be coupled to a second apparatus.
